(19) United States
(12) Patent Application Publication
(10) Pub. No.: US 2006/0022502 A1
(43) Pub. Date: Feb. 2, 2006

(54) Longitudinal guide for a vehicle seat

(75) Inventors: Burckhard Becker, Solingen (DE); Wilfried Beneker, Leichlingen (DE); Reiner Schulz, Dusseldorf (DE)

Correspondence Address: MCCARTER & ENGLISH LLP;CITYPLACE I, 185 ASYLUM STREET, HARTFORD, CT, 06103, US

(73) Assignee: C. Rob. Hammerstein GmbH & Co., KG

(21) Appl. No.: 11/190,438

(22) Filed: Jul. 27, 2005

(30) Foreign Application Priority Data
Jul. 28, 2004 (DE) 10 2004 036 661.6
Feb. 2, 2005 (DE) 10 2005 004 659.2

(51) Int. Cl. B60N 2/48

(52) U.S. Cl. 297/378.1

(57) ABSTRACT

The longitudinal guide for an automotive vehicle seat has two elongate rails, namely one bottom rail and one seat rail, and guide means in the form of roll and/or sliding bodies that are disposed between the rails. Each rail has, when viewed in profile, a) an L-shaped region formed by two L-legs and b) two end regions, each of which joins the L-shaped region and has multiple bends and against which the guide means are resting. The end regions of a rail are mutually interlocked to respectively form an encompassing region with a respective one of the end regions of the other rail. In each encompassing region when viewed in profile, two channels are respectively provided for guide means. Each encompassing region comprises a first channel having first confronting guide surfaces that extend substantially in the y-direction when viewed in the profile of the rails. Said guide surfaces fix the position of a guide means located between them in the z-direction but not in the y-direction.

The invention relates to a longitudinal guide for a vehicle seat according to the preamble of claim 1.

A longitudinal guide of the type mentioned herein above is known from DE 197 17 667 A1 and from U.S. Pat. No. 6,059,248 respectively. In the exemplary embodiments, the guide means are configured to be balls. Each encompassing region is implemented so as to be capable of forming a complete longitudinal guide all by itself. The discrete balls contact the respective rails at respective points. If one joins the contact points of a ball, this joining line is a straight line that is inclined at an angle in excess of 15 to 20° to the vertical.

In principle, the prior art longitudinal guide has proved efficient. However, precautions have to be taken to provide a permanent zero clearance fit of all the balls of the four channels against the rails. For this purpose, a certain bias within the encompassing regions and possibly a special individual adjustment are advantageous.

An advantage of the prior art longitudinal guide is that the two rails define quite a large free internal cross-section. This free internal cross-section can accommodate additional component parts such as a catch device, part of an electrical drive, part of a memory system and so on.

The invention aims at improving the longitudinal guide of the type mentioned herein above. It is an object of the invention to improve the prior art longitudinal guide in such a manner that certain shape differences in the profile of the various rails that are due to production can be tolerated and that a zero clearance fit of all the roll bodies against the rails is ensured, substantially eliminating re-finishing. The solution to this object is achieved by the longitudinal guide having the features of claim 1.

In this longitudinal guide, the roll bodies of each encompassing region have clear functions to perform. The roll bodies located in the first channel are mainly, preferably only, responsible for absorbing vertical forces, that is to say an occupant's weight and so on. The roll bodies of this first channel are fixed by the guide surfaces in the vertical direction but not in the horizontal direction. As a result, the guide surfaces are slidable relative to each other in the horizontal direction without being hindered by the roll bodies. This permits to accommodate production tolerances that translate into different relative positions of the guide surfaces.

The roll bodies located in the second channels are substantially responsible for the positioning of the two rails in a lateral relationship. They hardly absorb any carrying forces so that they transmit no weight in the vertical direction. The bias within the rails urges them against their guide surfaces, the second guide surfaces.

Preferably, the roll bodies in the first channels are configured to be rolls. Rolls are more suited to take the vertical loads. The roll bodies in the second channels are preferably implemented as balls. They need to absorb much less forces than the roll bodies of the first channel. It is however also possible to implement all of the roll bodies as balls.

It has been found advantageous to configure the second channel in such a manner that the second guide surfaces of this second channel fit substantially laterally against the roll bodies, meaning the balls. Preferably, the guide means rest against the second guide surface at contact points that lie in a straight line which in turn lies in the yz-plane and is inclined at an angle in excess of 45° to the z-axis. Due to the substantially lateral fixation of the balls of the second channels, which preferably lies in the y-direction, these balls are preferably responsible for laterally positioning and disposing the rails relative to each other. It has thereby been found advantageous to have the straight lines on which the contact points lie intersecting beneath the rail profile.

Whereas the roll bodies of the first channels are capable of sliding in the y-direction with respect to both the guide surface of the bottom rail and the guide surface of the seat rail and are preferably substantially retained in the y-direction by a cage, the guide means of the second channels are advantageously fixed in the yz-plane by the guide surfaces associated therewith and are only capable of moving parallel to the x-direction. Preferably, at least one of the second guide surfaces is configured to be concave when viewed in profile, meaning concave when viewed from the ball in said second channel. As a result, this ball has no degree of freedom in the yz-plane.

It is preferred that the guide means of at least one encompassing region be disposed in a cage. A cage dictates and permits to maintain the relationship of the guide means of the two channels of the encompassing region. A cage is particularly advantageous if rolls or non spherical bodies such as barrel-shaped cylinders are used.

The encompassing regions preferably have certain symmetry, with the end regions of at least one rail being more or less mirror-symmetrical. It is particularly advantageous if the positions of the guide means within the encompassing regions are mirror-symmetrical.

Other features and advantages will become more apparent upon reviewing the appended claims and the following non restrictive description of embodiments of the invention, given by way of example only with reference to the drawing.

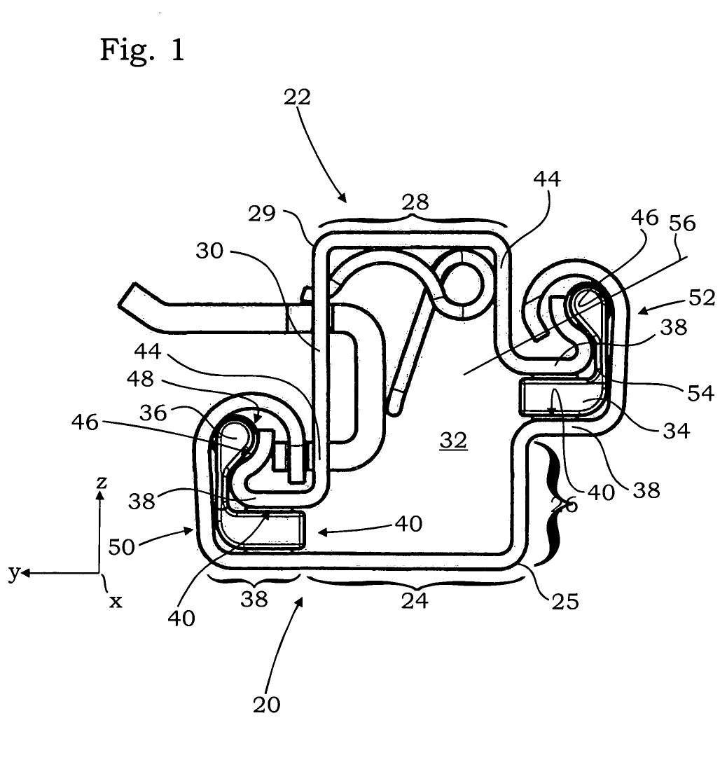

In its sole FIGURE (FIG. 1), the drawing shows a front view of a longitudinal guide.

A coordinate system with an x-axis, a y-axis and a z-axis is used for the description. The x-axis extends in the longitudinal direction of the rails, just like the viewing direction of FIG. 1. The y-axis extends in the horizontal, the z-axis in the vertical and is directed upward. When mounted in an automotive vehicle, the longitudinal guides are in parts horizontal; accordingly they are mounted in such a manner that the xyz-coordinate system of the vehicle can directly be used. In the majority of cases, the longitudinal guides are mounted so as to extend slightly upward at the front. In this case, the xyz-coordinate system of the vehicle has the same y-axis as the coordinate system chosen above for the longitudinal guide but it is rotated a certain angle, the angle of upward inclination of the longitudinal guide, about said y-axis.

In a known manner, the longitudinal guide consists of two rails, namely a bottom rail 20, also referred to as the lower rail, and a seat rail 22, also referred to as the upper rail. In FIG. 1, the rail profiles are implemented without a branching, they may be formed from a steel sheet blank such as by bending, stamping, rolling and the like. However, the rails could also be manufactured as extruded or pultruded profiles. The seat rail 22 can also be manufactured from two individual profile parts, as known from the document DE 197 17 667 mentioned herein above, see FIG. 2 of this document.

When viewed in profile, each rail 20, 22 has an L-shaped region located approximately in the center of its profile blank, said region being formed from two L-legs, namely the L-legs 24 and 26 of the bottom rail 20 and the L-legs 28, 30 of the seat rail 22. They commence at an apex 25 or 29 respectively that concurrently also is the apex of the profile. In the exemplary embodiment shown, the legs are disposed at a right angle with respect to one another. Each L-leg of a rail is parallel to a respective L-leg of the other rail. The angle between the L-legs could also be up to 20 to 30° larger or smaller than 90°. The L-legs substantially define a free inner volume within the rail profiles. This free inner volume, which is referred to as longitudinal channel 32, can be used for built-in elements. It has no guide means whatsoever. The invention provides the possibility to optimally adapt this longitudinal channel to the respective purpose of utilization of the longitudinal guide. Accordingly, quite large free cross-sections such as high and/or quite wide longitudinal channels can be realized.

When viewed in profile, each L-leg 24 to 30 is adjoined with an end region. Overall, each rail 20, 22 accordingly has an L-shaped region and two end regions. The end regions can extend from the respective one of the legs at an angle, in most cases at an angle of 90°; but they may also join in the same direction as the associated L-leg. On the one side, the end regions have a substantially hook-shaped configuration, on the other side, the guide means 34, 36 are resting against them. Overall, four channels of the guide means 34, 36 are provided. In each channel, there is a plurality of guide means of the same type, meaning either rolls 34 or balls 36.

In the embodiment shown, each of the end regions of the two rails have a profile part 38 that is connected to the adjacent L-leg. When viewed in its cross-section, which lies in the yz-plane, this profile part 38 extends parallel to the y-axis, that is to say, it lies in the xy-plane. The profile parts of the two rails each form two opposing pairs of first guide surfaces 40. These define a first channel 42 in which there are located the rolls 34. It can be seen that the rolls are not fixed by the first guide surfaces 40 in the y-direction. The first guide surfaces 40 however determine the position of the rolls 34 in the z-direction. In the y-direction, the first guide surfaces 40 are somewhat longer, preferably 30 to 50% longer than the corresponding axial dimension of the rolls 34.

In the lower, horizontal L-leg 24 of the bottom rail 20, the profile part 38 extends as a continuation of said L-leg 24. The other L-leg 26 extends in the z-direction over approximately only half the entire profile height, where it angles outward at an angle of 90° into the profile part 38. In the seat rail 22, these relationships are as follows: An intermediate portion 44 is adjoined to the L-legs 28, 30, in the case of the horizontal L-leg 28, this occurs at an angle of 90°, in the case of a vertical L-leg 30, said intermediate portion extends as a continuation of said leg. The intermediate portions 44 could also be considered a component part of the respective one of the L-legs. The respective one of the profile parts 38 in turn takes departure from said intermediate portions 44, said profile parts being disposed at an angle of 90° to the associated intermediate portion 44.

Beyond the profile part 38, each end region forms second guide surfaces 46 which again are oppositely disposed from each other. These guide surfaces however are configured in such a manner that at least one second guide surface is concave, meaning that it includes the ball resting against it. The second guide surfaces 46 are configured in such a manner that they prevent the guide means, which are here implemented as balls 36, from moving in the yz-plane. Inasmuch, they differ from the first guide surfaces 40, which allow movement of their associated guide means 34 in the y-direction. The two second guide surfaces 46 each form a second channel 48. Sliding means could be used instead of the guide means 34, 36, the balls 36 could for example be formed by elongate plastic rods, the rolls 34 could be realized by elongate sliding rods having a substantially rectangular cross-section.

The end regions of the rails 20, 22 are mutually interlocked and respectively form an encompassing region 50, 52. The profile in accordance with FIG. 1 has a left encompassing region 50 that is located in the lower left profile corner. The profile further has a right encompassing region 52 that is located on the upper right side of the profile and extends upward almost but not entirely as far as the L-leg 28. Coarsely, the encompassing regions 50, 52 have about half the height of the longitudinal channel 32 and about half the width of the longitudinal channel 32.

The guide means 34, 36 of each encompassing region 50, 52 are joined together and held in relationship to each other by a cage 54. A metal or plastic frame can be used as the cage 54 for example, said frame substantially contacting and holding the guide means in the x-direction. Usually, two identically built guide means 34, 36 are provided for each channel 42, 48, the cage 54 holding together either all of the guide means of one encompassing region or only the two respective guide means lying above each other in the z-direction, with two or more cages 54 being provided in the latter case.

As can be seen from FIG. 1, the first channels 42 are located beneath the second channels 48 in the encompassing regions 50, 52. In the case of the bottom rail 20, the first guide surface 40 and the second guide surface 46 are located on the inner surface of the end region the outer side of which forms the lower or the lateral outer surface of the longitudinal guide.

The two encompassing regions 50, 52 are located substantially diagonally opposite to each other. At least one of the rails 20, 22 is provided with an elastic bias. This rail acts as a leg spring, with the respective one of the L-legs and the respective one of the annexed end regions forming the spring legs and the spring movement about an axis extending in the x-direction passing through the respective one of the apexes 25 and 29 respectively. If the bottom rail 20 is configured to be a leg spring, it will spring inward about the apex 25, that is, its end regions will tend to move closer together. The reason therefore is that the bottom rail 20 is implemented as an encompassing rail. If the seat rail 22 is configured to be a leg spring, their two end regions tend to move away from each other. Usually, the two rails 20, 22 are provided with an elastic bias.

The second guide channels 44 of the seat rail 20 are located in immediate proximity to a respective one of a profile end. The second guide surfaces 46 of the bottom rail 20 are located at a certain distance from the free profile end.

If, in FIG. 1, one draws a straight line through the center of the two guide means 34, 36 of each encompassing region, these straight lines intersect beneath the profile of the longitudinal guide. They preferably intersect in the z-direction beneath a center-point of the longitudinal channel 34 at a downward offset from said center-point of about the vertical height of the longitudinal channel 32.

Each of the second guide surfaces 46 is concave. If one joins the center-points of the contact lines of the ball 36 with the two second guide surfaces, one obtains a straight line 56. This straight line 56 extends at an angle to the z-direction that is in excess of 45°. It is preferred that the angle range between 45° and 60°. It may be of up to 90°. This means that the balls 36 are much more fixed in the y-direction than in the z-direction.

Air gaps are provided in the y-direction between the rails 20, 22. As a result, the seat rail 22 can assume different positions in the y-direction with respect to the bottom rail 20. Manufacturing differences can be accommodated.

1-13. (canceled)

14. A longitudinal guide for an automotive vehicle seat comprising:
a longitudinal guide having two elongate rail means, each rail means comprising;
a bottom rail,
a seat rail, and
guide means in the form of at least one of roll and sliding bodies disposed between said bottom and seat rails, each of said bottom and seat rails having, when viewed in profile,
a) an L-shaped region formed by two L-legs, and
b) two end regions, each end region joining said L-shaped region and having multiple bends,
wherein the guide means are resting against said multiple bends, said end regions of one rail being mutually interlocked to each form an encompassing region with a respective one of said end regions of the other rail, two channels being respectively provided for said guide means in each encompassing region when viewed in profile, wherein said each encompassing region comprises a first channel of said two channels, that first confronting guide surfaces are formed in said first channel which guide surfaces extend substantially in the y-direction when viewed in the profile of said bottom and seat rails and that said guide surfaces define a position of a guide means located between said guide surfaces in the z-direction but not in the y-direction.

15. The longitudinal guide as set forth in claim 14, wherein said each encompassing region comprises a second channel, and wherein said second channel comprises confronting second guide surfaces, one of said second guide surfaces at least being concave when viewed in the profile of said rails.

16. The longitudinal guide as set forth in claim 15, wherein a second guide means is disposed in said second channel and rests against said second guide surfaces at contact points lying on a straight line which straight line lies in a yz-plane and is inclined at an angle in excess of 45° to the z-axis.

17. The longitudinal guide as set forth in claim 14, wherein at least one of two said encompassing regions and said guide means are disposed in a cage.

18. The longitudinal guide as set forth in claim 14, wherein said first guide surfaces are planar.

19. The longitudinal guide as set forth in claim 14, wherein at least one of said second guide surfaces is concave and wherein said second guide surfaces define a position of said guide means in the yz-plane.

20. The longitudinal guide as set forth in claim 14, wherein, in said encompassing regions, said first channel is located beneath said second channel.

21. The longitudinal guide as set forth in claim 14, wherein, in an encompassing region of said encompassing regions, a first guide surface extends as a continuation of an adjacent L-leg of said two L-legs.

22. The longitudinal guide as set forth in claim 14, wherein one of said two first guide surfaces forming said bottom rail extends as a continuation of an adjacent L-leg of said two L-legs and wherein the other said first guide surface thereof extends as far as a corresponding adjacent L-leg of said two L-legs at an angle of about 90°.

23. The longitudinal guide as set forth in claim 14, wherein two said encompassing regions are located substantially diagonally opposite to each other.

24. The longitudinal guide as set forth in claim 14, wherein at least one of said bottom and seat rails comprises an elastic bias, said rails forming a leg spring the legs of which are formed by said two L-legs.

25. The longitudinal guide as set forth in claim 14, wherein a position of said guide means in one of two said encompassing regions is mirror-symmetrical to aposition of said guide means in the other of two said encompassing regions.

26. The longitudinal guide as set forth in claim 14, wherein air gaps are provided between said bottom and seat rails in the y-direction.

27. The longitudinal guide as set forth in claim 14, wherein said first guide surfaces extend in the xy-plane.

28. The longitudinal guide as set forth in claim 14, wherein identically built cages are used for said guide means of two said encompassing regions of two said encompassing regions.
